(19) United States
(12) Patent Application Publication
(10) Pub. No.: US 2026/0048652 A1
(43) Pub. Date: Feb. 19, 2026

(54) THERMAL MANAGEMENT SYSTEM

(71) Applicant: Robert Bosch GmbH, Stuttgart (DE)

(72) Inventor: Markus Remlinger, Miesbach (DE)

(21) Appl. No.: 19/301,263

(22) Filed: Aug. 15, 2025

(30) Foreign Application Priority Data
Aug. 15, 2024 (DE) 10 2024 207 772.0

(51) Int. Cl. B60K 11/02; B60R 16/08; F16F 15/02

(52) U.S. Cl. CPC B60K 11/02; B60R 16/08; F16F 15/021

(57) ABSTRACT

A thermal management system (10) for a vehicle includes a coolant module (100) of a coolant circuit and a refrigerant module (200) of a refrigerant circuit. The thermal management system (10) also includes a support structure (14) for receiving the coolant module (100) and the refrigerant module (200). The support structure (14) is configured to attach the thermal management system (10) to a vehicle. The support structure (14) comprises at least one first vibration decoupling element (20a, 20b) for main vibration decoupling in a first spatial direction (x₁, x₂) and at least one second vibration decoupling element (22a, 22b) for main vibration decoupling in a second spatial direction (y₁, y₂).

### BACKGROUND

The invention proceeds from a thermal management system and a support structure for a thermal management system.

Thermal management systems with a coolant module of a coolant circuit and a refrigerant module of a refrigerant circuit are already known. It is also known to hydraulically connect the modules to each other.

### SUMMARY

The invention proceeds from a thermal management system for a vehicle, comprising at least one coolant module of a coolant circuit and at least one refrigerant module of a refrigerant circuit, wherein the thermal management system comprises at least one support structure for receiving the coolant module and the refrigerant module, wherein the support structure is configured to attach the thermal management system to a vehicle. According to the present invention, it is proposed that the support structure comprises at least one first and at least one second vibration decoupling element, wherein the first vibration decoupling element is configured to decouple main vibrations in at least a first spatial direction and the second vibration element is configured for main vibration decoupling in at least a second spatial direction.

In the context of the present invention, main vibration decoupling in a defined spatial direction is to be understood as vibration decoupling in which vibrations occurring along a specific spatial direction are significantly reduced.

The spatial direction refers here to a precisely defined spatial orientation in which vibration decoupling is primarily to be carried out. This spatial direction may be defined in a three-dimensional coordinate system, which is usually described by the axes X, Y and Z, as well as in relation to a specific orientation of a component or a structure within a system.

“Main vibration decoupling” refers specifically to the primary or dominant mechanism for attenuating the transmission of vibrations that might occur in this spatial direction.

The thermal management system according to the invention, comprising a double vibration-decoupled bracket, has the advantage that vibrations from the vehicle to the thermal management module and from the thermal management module to the vehicle can be particularly efficiently decoupled. The subcomponents of the thermal management system have different main vibration directions, which can be particularly advantageously attenuated. In this way, a particularly low-noise, low-vibration coupling of the modules may be provided on the vehicle. At the same time, the proposed solution is particularly simple in terms of design, as only one common support structure and thus only one common attachment structure is required on the vehicle.

In the context of the present invention, a support structure is understood to be a structural element that supports and distributes the weight of the coolant module and the refrigerant module. The support structure provides particularly advantageous stability and strength. Further, in the context of the present invention, a vibration decoupling element may in particular be understood to mean one or more components configured to isolate and/or attenuate vibrations and/or oscillations between the vehicle and the refrigerant module and coolant module.

In the context of the present invention, the spatial directions each refer to a specific direction in a three-dimensional space, in particular the installation space in the vehicle. In this context, the first, second and third spatial directions each refer to three orthogonal spatial directions at right angles to one another, in particular a substantially first horizontal extension in one direction, a substantially second horizontal extension in a second direction, perpendicular to the first direction, and a substantially vertical extension. In this context, a first spatial direction and a second spatial direction are thus to be understood in particular as a vector within this three-dimensional system along which main vibrations are to be decoupled.

According to a particularly advantageous further development of the invention, the support structure comprises at least a third decoupling element, wherein the third decoupling element is configured to be decoupled in a third spatial direction.

A particularly stable and at the same time maximally decoupled structure can be provided in particular in that the support structure has at least one first main support element to attach to the vehicle and at least one secondary support element, wherein the coolant module and/or the refrigerant module are supportingly attached to the secondary support element, wherein the secondary support element comprises at least one first attachment connection to attach to the main support element, wherein the first attachment connection comprises at least a first vibration decoupling element. In this way, the secondary support element is formed in a first vibration direction decoupled from the main support element.

According to an advantageous further development of the invention, the first attachment connection comprises at least a third vibration decoupling element. In this way, vibration transmissions in two spatial directions from the secondary support element to the main support element can be reduced in a particularly advantageous manner.

A particularly stable support structure can be provided in particular by the main support element and/or the secondary support element being integrally formed. Preferably, the main support element and the secondary support element lie substantially flat against each other. Preferably, the secondary support element is connected to the main support element with particularly low torque.

In accordance with a particularly simple connection to the vehicle, the main support element comprises at least one second attachment connection to attach to the vehicle, wherein the second attachment connection comprises at least one second vibration decoupling element. In this way, the functions of vibration decoupling, receiving the modules and attaching them to the vehicle can be particularly advantageously configured with particularly advantageous functional separation.

According to an advantageous further development of the invention, the second attachment connection comprises at least a third vibration decoupling element. In this way, vibration transmissions in two spatial directions from the main support element to the vehicle can be reduced in a particularly advantageous manner.

To provide a particularly stable, low-vibration connection to the vehicle, according to an advantageous further development of the invention, the second attachment element comprises at least two, preferably at least three, attachment sections to attach to the vehicle. Preferably, each of the attachment sections comprises at least one vibration decoupling element.

Vibration decoupling that is particularly easy to mount can in particular be provided in that the support structure comprises a plurality of receptacles for the vibration decoupling elements, wherein a vibration decoupling element comprises at least one rubber bushing, which is rotationally symmetrical to a rotational axis and can be pressed into the receptacle. It is also contemplated that the vibration decoupling elements may have additional dampening elements. For example, additional foams or material recesses may be introduced into the vibration decoupling elements.

According to a particularly advantageous further development of the invention, the thermal management system comprises at least one hydraulic connection element comprising a plurality of hydraulic guides for hydraulically connecting the coolant circuit to the refrigerant circuit, wherein the hydraulic connection element comprises at least one compensating element for receiving relative movements between the coolant module and the refrigerant module. Preferably, the hydraulic connection element comprises at least one substantially rigid hydraulic connection section, wherein the hydraulic connection section is movably mounted relative to further hydraulic components via the compensating element.

The hydraulic connection element may be mechanically fixedly connected to each other by the coolant module and the refrigerant module, and at the same time small relative movements may be compensated for via the at least one compensating element. These relative movements can in particular be caused by thermally-related movements of the modules with respect to one another. It is also contemplated that the compensating element may compensate for vibrations of subcomponents, such as a compressor of the refrigerant module. In particular, a vibration decoupling between the coolant module with its large resonant body due to the first fluid distributor element and the vibrating e-compressor of the refrigerant module may advantageously significantly reduce noise formation. In this way, a particularly tight, stable and easy to install thermal management system can be provided, which is simultaneously capable of compensating for relative movements between the coolant module and the refrigerant module. Pre-assembly of the assemblies can be mapped in a particularly reliable process with the proposed solution. Preferably, the hydraulic connection between the coolant module and the refrigerant module is substantially hose-free and/or free of quick connectors.

Preferably, the coolant module comprises at least a first fluid distributor element. This fluid distributor element is preferably substantially plate-shaped and has a plurality of integrated, first fluid channels. According to an advantageous further development of the invention, the coolant module further comprises a plurality of fluid handling elements. Preferably, these fluid handling elements are configured as fluid pumps and/or fluid valves. According to one embodiment of the invention, the fluid handling elements are attached directly on the fluid distributor element. It is also contemplated that the fluid handling elements may be formed at least partially integrated into the fluid distributor unit. According to a particularly advantageous further development of the invention, the fluid handling elements are substantially completely embedded in the housing of the fluid distributor element. The coolant module is preferably configured as a pre-assembled assembly that can be handled as a unit in the production line. Preferably, the first fluid distributor element of the coolant module is configured as a plastic injection molded part.

A particularly stable and at the same time particularly vibration-optimized connection can in particular be provided in that the hydraulic connection element is configured as part of the support structure, in particular as part of the secondary support element.

Preferably, the coolant module comprises at least a second fluid distributor element. Preferably, the second fluid distributor element is substantially plate-shaped. Preferably, at least one heat exchanger, in particular a coolant-refrigerant heat exchanger, is attached to the second fluid distributor element and is fluidly attached. Preferably, the second fluid distributor element comprises a plurality of at least partially integrated second fluid guides. Preferably, the second fluid guides are configured as coolant guides. According to a particularly advantageous further development of the invention, the refrigerant module further comprises a second heat exchanger, in particular a coolant-refrigerant heat exchanger, which is also attached to the second fluid distributor element and is configured to be fluidly connected. According to an advantageous further development, the refrigerant module further comprises a compressor. Preferably, the compressor is attached to the second fluid distributor element. The coolant module comprising the heat exchanger and at least the compressor is preferably configured as a pre-assembled assembly that can be handled as a unit in the production line. According to an advantageous further development of the invention, the refrigerant module further comprises at least one expansion valve. The refrigerant may in particular be propane (R290), CO2 (R744), R-1234yf or a refrigerant blend, preferably comprising propane. Preferably, it is a propane-containing refrigerant, which consists of at least 90%, 95%, 98%, or 99% propane, for example.

A particularly simple and at the same time tight connection can be provided in particular by the fact that the compensating element comprises at least one, preferably a plurality of bearings, preferably sliding bearings, in particular, spherical bearings. Preferably, the compensating element is configured to receive a relative movement in at least one, preferably two, particularly preferably three, spatial directions.

A particularly stable connection may be provided in particular by the hydraulic connection element comprising a substantially rigidly formed hydraulic connection section and the compensating element, wherein the hydraulic connection section and the compensating element form hydraulic guides of the hydraulic connection element, wherein the hydraulic connection section has a predominant portion of the hydraulic guides of the hydraulic connection element.

According to an advantageous further development of the invention, the first and/or second and/or third vibration decoupling elements are arranged in the area of the compensating element. Preferably, the vibration decoupling is therefore arranged particularly close to the hydraulic connection and thus to larger resonant bodies, such as the fluid distributor elements.

### BRIEF DESCRIPTION OF THE DRAWINGS

Exemplary embodiments of the thermal management system are illustrated in the drawings and explained in more detail in the description below. Shown are:

FIG. 1 a perspective view of a thermal management system according to a first embodiment,

FIG. 2 a perspective view of a support structure according to the first embodiment,

FIG. 3 a perspective view of a coolant module,

FIG. 4 a perspective view of a refrigerant module.

### DETAILED DESCRIPTION

In the different design variants, the same parts are given the same reference numbers.

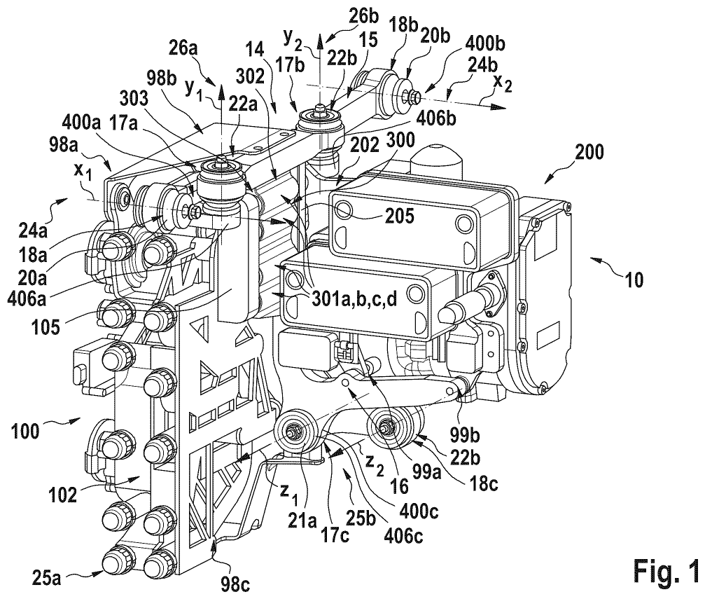

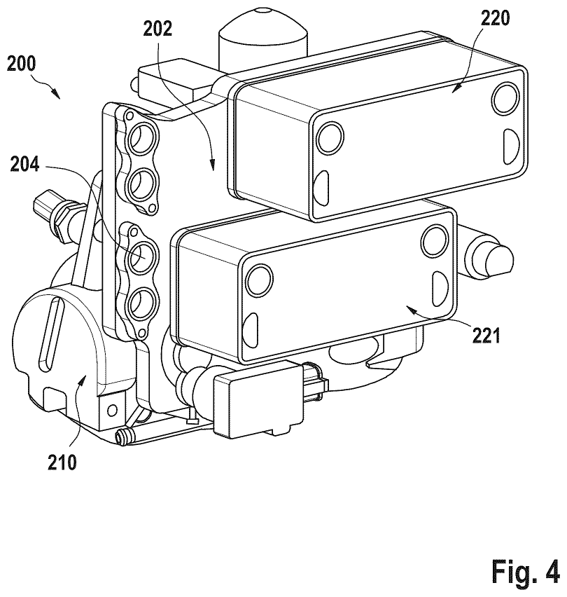

FIG. 1 shows a thermal management system 10. The thermal management system 10 includes at least one coolant module 100 and at least one refrigerant module 200. A coolant module 200 is described by way of example in FIG. 5. A refrigerant module 200 is described by way of example in FIG. 4.

The coolant module 100 and refrigerant module 200 are preferably each assembled as separate assemblies. The modules are then mounted to a common assembly, the thermal management system 10.

This thermal management system 10 is then attached as a unit in the vehicle. For attachment in the vehicle, the thermal management system 10 comprises a support structure 14. Preferably, both the coolant module 100 and the refrigerant module 200 are supportingly attached to the support structure 14.

According to the present invention, the support structure 14 comprises at least a first vibration decoupling element 20 and at least a second vibration decoupling element 22. According to the embodiment of the invention shown in FIG. 1, the support structure 14 comprises two first vibration decoupling elements 20a, 20b and two second vibration decoupling elements 22a, 22b.

The first vibration decoupling elements 20a, 20b preferably have main vibration decoupling formed in a first spatial direction x₁, x₂. The second vibration decoupling elements 22a, 22b preferably have main vibration decoupling formed in a second spatial direction y₁, y₂.

Preferably, the first vibration decoupling elements 20a, 20b are formed substantially rotationally symmetrically to a first axis of rotation 24a, 24b. Preferably, the first axis of rotation 24a, 24b is configured substantially parallel to the first spatial direction x₁, x₂.

Preferably, the second vibration decoupling elements 22a, 22b are formed substantially rotationally symmetrically to a second axis of rotation 26a, 26b. Preferably, the first axis of rotation 26a, 26b is configured substantially parallel to the second spatial direction y₁, y₂. Preferably, the first spatial direction x₁, x₂ is formed substantially orthogonally to a second spatial direction y₁, y₂.

According to the embodiment of the invention shown in FIG. 1, the support structure 14 comprises at least a third vibration decoupling element 21. Preferably, the support structure 14 comprises at least two third vibration decoupling elements 21a, 21b. The third vibration decoupling elements 21a, 21b preferably comprise a main vibration decoupling in a third spatial direction z₁, z₂.

Preferably, the third vibration decoupling elements 21a, 21b are formed substantially rotationally symmetrically to a third axis of rotation 25a, 25b. Preferably, the third axis of rotation 25a, 25b is configured substantially parallel to the third spatial direction z₁, z₂. Preferably, the third spatial direction z₁, z₂ is formed substantially orthogonal to the second and third spatial directions x₁, x₂, y₁, y₂.

According to the embodiment of the invention shown in FIG. 1, the thermal management system for fluidly connecting the coolant module 100 to the refrigerant module 200 is provided with a hydraulic connection element 300. The hydraulic connection element 300 may be formed as part of the coolant module 100 or the refrigerant module 200. According to the embodiment of the invention shown in FIG. 1, the hydraulic connection element 300 is formed separately from the coolant module 100 and the refrigerant module 200.

The hydraulic connection element 300 includes a hydraulic connection section 302 and a compensating element 303. The hydraulic connection section 302 is configured as a fluid distributor element and has integrated hydraulic guides 301a, 301b, 301c, 301d.

Preferably, the hydraulic connection section 302 is substantially plate-shaped. Preferably, the hydraulic connection section 302 is substantially rigidly formed and preferably forms at least a portion of the support structure 14 for connection from the vehicle. The compensation of the relative movements between the coolant module 100 and the refrigerant module 200 is preferably substantially accomplished by a compensating element 303. According to the embodiment of the invention shown in FIG. 1, the compensating element 303 is configured as a spherical bearing 303.

As can be seen in FIG. 1, the coolant module 100 comprises a first fluid distributor element 102 and the refrigerant module 202 comprises a second fluid distributor element 202. The fluid distributor elements 102, 202 are hydraulically connected to each other via the hydraulic connection element 300. The coolant module 100 is connected to the support structure 14 via attachment elements 98a, 98b, 98c. The refrigerant module 200 is connected to the support structure 14 via further attachment elements 99a, 99b. The attachment elements 98a, 98b, 98c, 99a, 99b are preferably formed at least partially as bolted connections.

According to the embodiment of the invention shown in FIG. 1, the support structure 14 comprises a main support element 15 and a secondary support element 16. Both the coolant module 100 and the refrigerant module 200 are attached to the secondary support element 16. Preferably, the coolant module 100 and the refrigerant module 200 are attached to the secondary support element 16 by means of the attachment elements 98a, 98b, 98c, 99a, 99b.

The hydraulic connection section 302 is formed as part of the secondary support element 16. The secondary support element 16 is connected to the main support element 15 via a first attachment connection 17. Preferably, the secondary support element 16 is configured as a frame element, preferably made of aluminum.

According to the embodiment of the invention shown in FIG. 1, the secondary support element 16 is configured to be connected to the main support element 15 by means of a first attachment connection 17. The attachment connection 17 preferably comprises at least a first and a second attachment section 17a, 17b. The attachment sections 17a, 17b preferably each comprise at least a second vibration decoupling element 22a, 22b for main vibration decoupling in a second spatial direction y₁, y₂ to reduce the vibration transmission between the secondary support element 16 and the main support element 15.

According to the embodiment of the invention shown in FIG. 1, the first attachment connection 17 comprises at least one third attachment section 17c. Preferably, the third attachment section 17c comprises at least a third vibration decoupling element 21a for vibration decoupling in a third spatial direction z₁. In this way, vibration transmission in at least two spatial directions y, z between the secondary support element 16 and the main support element 15 can be reduced in a particularly advantageous manner.

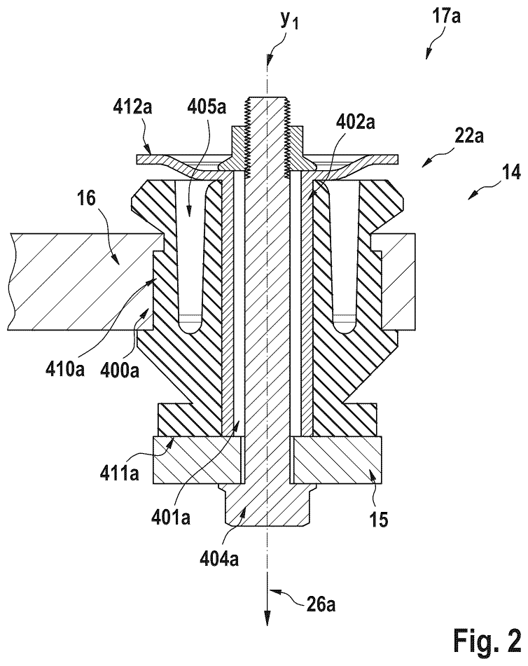

An attachment section 17a of a first attachment connection 17 comprising a second vibration decoupling element 22a is exemplarily illustrated in FIG. 2.

Preferably, the first attachment connection 17 is arranged within the second attachment connection 18. Preferably, the attachment sections 17a, 17b, 17c of the first attachment connection 17 are arranged particularly close to the hydraulic connection element 300, in particular to the compensating element 303. Preferably, the attachment sections 17a, 17b, 17c are arranged particularly close to the center of gravity. In this way, vibration transmission of the components to the main support element 15 and thus to the vehicle can be reduced in a particularly advantageous manner while the load on the compensating element 303 can be minimized in a particularly advantageous manner.

According to the embodiment of the invention shown in FIG. 1, the main support element 15 for connection to the vehicle, in particular subcomponents in the interior of the vehicle, in particular at least one body part, comprises a second attachment connection 18. Preferably, the second attachment connection 18 comprises at least a first and a second attachment section 18a, 18b. Preferably, the attachment connection 18 comprises a third attachment section 18c. Preferably, the first and second attachment sections 18a, 18b of the main support element 15 each have at least one first vibration decoupling element 20a, 20b for main vibration decoupling in a first spatial direction x₁, x₂. Preferably, the third attachment section 18c comprises at least a third vibration decoupling element 21b for the main vibration decoupling in a third spatial direction z₂. In this way, vibration transmission in at least two spatial directions x, z between the secondary support element 16 and the main support element 15 can be reduced in a particularly advantageous manner.

According to an advantageous further development of the invention, the attachment sections 17a, 17b, 17c and 18a, 18b, 18c are substantially identical in function. Preferably, the vibration decoupling elements 20a, 20b, 21a, 21b, 22a, 22b are substantially identical.

According to the embodiment of the invention shown in FIG. 1, the first fluid distributor element 102 comprises a first connection piece 105 and the second fluid distributor element 202 comprises a second connection piece 205. The hydraulic connection element 300 comprising the compensating element 303 is arranged between the connection pieces 105, 205.

The compensating element 303 is configured as a bearing element according to the invention shown in FIG. 1. According to the embodiment of the invention shown in FIG. 1, each of the fluid guides to be connected comprises a bearing 303a, 303b, 303c, 303d. This bearing may compensate for the relative movements between the modules. According to the embodiment of the invention shown in FIG. 1, bearings 303a, 303b, 303c, 303d are each configured as spherical bearings. Such a spherical bearing is shown by way of example in FIG. 2.

As can be seen in FIG. 1, according to a preferred further development of the invention, the rigid hydraulic connection section 302 forms part of the support structure 14. The compensating element 303 allows the coolant module 100 and the coolant module to be hydraulically mechanically fixedly connected to each other while permitting relative movements between the modules. Preferably, the forces of the relative movements are transferred to the sealing locations in the bearing of the fluid guides, thus advantageously reducing the likelihood of leakage. At the same time, the “spherical flange” allows for ease of assembly by plugging together the hydraulic connections of the coolant modules 100 and the refrigerant modules 200. This hydraulic connection by the hydraulic connection element 300 may further be tested easily and reliably. The hydraulic connection element 300 with the compensating element 303 allows for a particularly advantageous absence of hoses.

As can be seen in FIG. 1, the hydraulic connection section 302 and the compensating element 303 form the hydraulic guides 301 of the hydraulic connection element 300, wherein the hydraulic connection section 302 has a majority of the hydraulic guides 301 of the hydraulic connection element 300. Accordingly, the compensating element 302 bridges only a very small section of the fluid guides between the coolant module 100 and the refrigerant module 200.

According to the embodiment of the invention shown in FIG. 1, the thermal management system 100 comprises substantially three fluid distributors. The coolant module 100 includes a first fluid distributor element 102 having at least partially integrated first fluid guides. The coolant module 200 comprises at least a second fluid distributor element 202, having at least partially integrated second fluid guides, and the hydraulic connection section 302 is configured as a third fluid distributor element having at least partially integrated hydraulic guides 301.

According to the embodiment of the invention shown in FIG. 1, the bearings 303a, 303b, 303c, 303d are arranged between the hydraulic connection section 302 and the first fluid distributor element 102. Preferably, each of the hydraulic guides 301a, 301b, 301c, 301d has a bearing 303a, 303b, 303c, 303d. However, it is also contemplated that alternatively or additionally, bearings 303a, 303b, 303c, 303d may be arranged between the hydraulic connection section 302 and the second fluid distributor element 202.

According to the embodiment of the invention shown in FIG. 1, the first 102 comprises a first connection flange 105 comprising the first fluid guides 104 of the first fluid distributor element 102. The second fluid distributor element 204 of the refrigerant module 200 further comprises a second connection flange 205. It is contemplated that the two connection flanges 105, 205 are each connected to one another directly via respective spherical bearings 303a, 303b, 303c, 303d. However, according to the embodiment of the invention shown in FIG. 1, a separate connector piece 302 is arranged therebetween.

In FIG. 2, a cut through a first attachment section 17a of a first attachment connection 17 to attach the secondary support element 16 to the main support element 15 is shown.

According to the embodiment of the invention shown in FIG. 2, the secondary support carrier element 16 comprises a first receptacle 400a. The first receptacle 400a is configured as a through-opening in the secondary support element 16. Within the receptacle 400a, a second vibration decoupling element 22a is arranged or pressed in. The second vibration decoupling element 22a is preferably substantially formed as a rubber bushing. The rubber bushing has a cylindrical shape that is essentially rotationally symmetrical with respect to a second axis of rotation 26a. The rubber bushing preferably has a through-opening 401a. A guide element 402a is arranged within the through-opening 401a. The guide element 402a is preferably configured to be dimensionally stable as a guide bushing. An attachment element, in particular a screw 404a, may be guided within the guide bushing.

According to the embodiment of the invention shown in FIG. 2, the rubber bushing comprises at least one material recess 405a to optimize the dampening function. Preferably, the material recess 405a is formed as a circumferential groove extending substantially in the direction of the axis of rotation 26a. Preferably, the groove 405a extends at least halfway through the rubber bushing. Preferably, the second vibration decoupling element 22a is configured for main vibration decoupling in a second spatial direction y₂.

To connect the main support element 15, the main support element 15 has a second receptacle 406a. Preferably, the second receptacle 406a is configured as a through-opening in the main support element 15. Preferably, the attachment element 404a intersects the first and second receptacles 400a, 406a and braces them together via the guide bushing 402a. Preferably, the second vibration decoupling element 22a forms a first active surface pair 410a to the secondary support element 16 and a second pair of active surfaces 411a to the main support element 15, such that the vibration-reducing force conduction between the main support element 15 and the secondary support element 16 occurs via the second vibration decoupling element 22a. Preferably, the main support element 15 lies flat against an axial stop surface 412a of the second vibration decoupling element 22a.

According to a preferred further development of the invention, the attachment section 17a comprises a clamping element 412a for tensioning the main support element 15 with the secondary support element 16 via the attachment element 404a. Preferably, the clamping element 412a is connected to the guide element 402a, in particular is integrally formed.

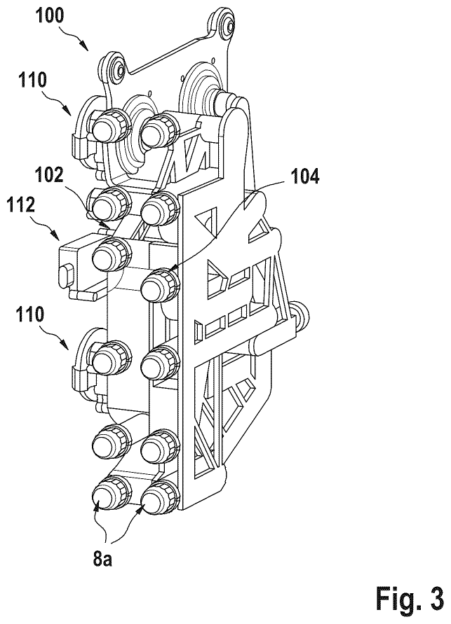

FIG. 3 shows, by way of example, a coolant module 100 for a thermal management system 10. The first fluid distributor unit 102 has a plurality of hydraulic connections 8a which can be connected to cooling lines. A plurality of coolant pumps 110 and coolant valves 112 are attached to the first fluid distributor unit 102. It is contemplated that the coolant pumps 110 and/or coolant valves 112 may be formed at least partially integral with the housing of the first fluid distributor unit 102. For example, the fluid distributor unit 102 may include chambers for receiving subcomponents of the coolant pumps 110 and/or coolant valves 112.

According to the embodiment of the invention shown in FIG. 3, the first fluid distributor element 102 is substantially plate-shaped. The first fluid distributor element 102 comprises first fluid guides 104. The fluid guides are preferably configured as fluid channels. Preferably, the fluid guides 104 are formed integrally with the housing of the fluid distributor element 102.

According to the embodiment of the invention shown in FIG. 3, the first fluid distributor element 102 is configured as a plastic injection molded part. Preferably, the first fluid distributor element 102 has a plurality of parts. According to the embodiment of the invention shown in FIG. 3, the integrated fluid guides 104 are closed by a lid element of the first fluid distributor element 102.

It is expressly emphasized herein that the features of the first fluid distributor element 102 and the coolant module 100 described above may not only be used in the combination discussed herein, but may also be used advantageously in other combinations and, where appropriate, in a unique setting. The combinations described herein are therefore merely to be understood as examples for a better understanding of the invention, but are not intended to further limit its configuration beyond the limitations stated in the claims.

FIG. 4 illustrates an exemplary refrigerant module 200 for a thermal management system 10. The refrigerant module 200 comprises a second fluid distributor element 202, a compressor 210 for compressing a refrigerant, particularly one containing propane, a first heat exchanger 220, a second heat exchanger 221, one or more sensors configured, for example, as a temperature sensor and/or pressure sensor, and for providing data for controlling the refrigerant circuit, and an expansion valve. The compressor 210, the first heat exchanger 220 and the second heat exchanger 221 are supported by the second fluid distributor element 202 and are mechanically rigidly connected to it.

The compressor 210 is fluidly conductively connected to a refrigerant inlet of the first heat exchanger 220 on the pressure side and to a refrigerant outlet (not visible) of the second heat exchanger 221 on the suction side. The first heat exchanger may also be referred to as a liquid cooled condenser (LCC), while the second heat exchanger is also referred to as a chiller.

According to the embodiment of the invention shown in FIG. 4, the second fluid distributor element 202 is embodied as a monolithic component, for example as a material block (e.g., metal block) with functional bores. The material block forms a base body of the second fluid distributor element 202. For example, the material block may be made entirely or partially of a metal or metal alloy, for example copper, iron, or aluminum, or an alloy of one or more of these metals, for example aluminum alloy, brass, bronze, steel, or the like. It is also contemplated that the second fluid distributor element 202 may be formed by plates of the at least one heat exchanger 220, 221.

As mentioned previously, the compressor 210, the first heat exchanger 220, and the second heat exchanger 221 are supported by the second fluid distributor element 202. To this end, according to an advantageous further development of the invention, the second fluid distributor element 202 comprises compressor attachments and heat exchanger attachments configured to attach the compressor 210 or the first and second heat exchangers 220, 221 to the second fluid distributor element 202.

According to an advantageous further development of the invention, the second fluid distributor element 202 is plate-shaped. Preferably, the second fluid distributor element 202 is arranged between the compressor 210 and the heat exchanger unit, such that the second fluid distributor element 202 is arranged at least close to a center of mass of the refrigerant circuit 200. As can be seen in FIG. 6, the second fluid distributor element 202 comprises second fluid guides 204. These second fluid guides 204 are preferably integrated into the second fluid distributor element 202. Preferably, the second fluid guides 204 are configured as bores in the material block. According to the embodiment of the invention shown in FIG. 6, the second fluid distributor element 202 comprises a second connection flange 205.

The refrigerant may in particular be propane (R290), CO2 (R744), R-1234yf or a refrigerant blend, preferably comprising propane. Preferably, it is a propane-containing refrigerant, which consists of at least 90%, 95%, 98%, or 99% propane, for example.

It is expressly emphasized herein that the features of the second fluid distributor element 202 or the refrigerant module 200 described above may not only be used in the combination discussed herein, but may also be used advantageously in other combinations and, where appropriate, in a unique setting. The combinations described herein are therefore merely to be understood as examples for a better understanding of the invention, but are not intended to further limit its configuration beyond the limitations stated in the claims.

1. A thermal management system (10) for a vehicle, comprising at least one coolant module (100) of a coolant circuit and at least one refrigerant module (200) of a refrigerant circuit, wherein the thermal management system (10) comprises at least one support structure (14) for receiving the coolant module (100) and the refrigerant module (200), wherein the at least one support structure (14) is configured to attach the thermal management system (10) to a vehicle, wherein the support structure (14) comprises at least a first vibration decoupling element (20a, 20b) for main vibration decoupling in a first spatial direction (x₁, x₂) and at least one second vibration decoupling element (22a, 22b) for main vibration decoupling in a second spatial direction (y₁, y₂).

2. The thermal management system (10) according to claim 1, wherein the at least one support structure (14) comprises at least a third vibration decoupling element (21a, 21b), wherein the third vibration decoupling element (21a, 21b) is configured for main vibration decoupling in a third spatial direction (z₁, z₂).

3. The thermal management system (10) according to claim 1, wherein the at least one support structure (14) comprises at least one main support element (15) to attach to the vehicle and at least one secondary support element (16), wherein the coolant module (100) and/or the refrigerant module (200) are supportingly attached to the secondary support element (16), wherein the secondary support element (16) comprises at least one first attachment connection (17) to attach to the at least one main support element (15), wherein the at least one first attachment connection (17) comprises at least one first vibration decoupling element (20a, 20b).

4. The thermal management system (10) according to claim 3, wherein the at least one main support element (15) and/or the at least one secondary support element (16) are integrally formed.

5. The thermal management system (10) according to claim 3, wherein the at least one main support element (15) comprises at least one second attachment connection (18) to attach to the vehicle, wherein the at least one second attachment connection (18) comprises at least one second vibration decoupling element (22a, 22b).

6. The thermal management system (10) according to claim 1, wherein the thermal management system (10) comprises at least one hydraulic connection element (300) comprising a plurality of hydraulic guides (301a, 301b, 301c, 301d) for hydraulically connecting the coolant circuit to the refrigerant circuit, wherein the at least one hydraulic connection element (300) comprises at least one compensating element (303) for receiving relative movements between the at least one coolant module (100) and the at least one refrigerant module (200).

7. The thermal management system (10) according to claim 6, wherein the at least one compensating element (303) comprises at least one bearing (303a, 303b, 303c, 303d).

8. The thermal management system (10) according to claim 6, wherein the at least one hydraulic connection element (300) comprises a substantially rigidly formed hydraulic connection section (302) and the at least one compensating element (303), wherein the hydraulic connection section (302) and the at least one compensating element (303) form the hydraulic guides (301) of the at least one hydraulic connection element (300), wherein the hydraulic connection section (302) comprises a majority of the hydraulic guides (301) of the at least one hydraulic connection element (300).

9. The thermal management system (10) according to claim 2, wherein the first and/or second and/or third vibration decoupling elements (20a, 20b, 21a, 21b, 22a, 22b) are arranged in an area of a compensating element (303) for receiving relative movements between the at least one coolant module (100) and the at least one refrigerant module (200).

10. The thermal management system (10) according to claim 6, wherein the at least one compensating element (303) is configured for receiving a relative movement in at least one spatial direction (x₁, x₂, y₁, y₂, z₁, z₂).

11. A support structure for a thermal management system (10) according to claim 1.

12. The thermal management system (10) according to claim 3, wherein the first attachment connection (17) further comprises at least one third vibration decoupling element (21a, 21b).

13. The thermal management system (10) according to claim 5, wherein the at least one second attachment connection (18) further comprises at least one third vibration decoupling element (21a, 21b).

14. The thermal management system (10) according to claim 6, wherein the at least one hydraulic connection element (300) is configured as part of the at least one support structure (14).

15. The thermal management system (10) according to claim 14, wherein the at least one hydraulic connection element (300) is configured as part of a secondary support element (16).

16. The thermal management system (10) according to claim 7, wherein the at least one compensating element (303) comprises a plurality of bearings (303a, 303b, 303c, 303d).

17. The thermal management system (10) according to claim 16 wherein the bearings are sliding bearings or spherical bearings.

18. The thermal management system (10) according to claim 10, wherein the at least one compensating element (303) is configured for receiving a relative movement in at least two spatial directions (x₁, x₂, y₁, y₂, z₁, z₂).

19. The thermal management system (10) according to claim 18, wherein the at least one compensating element (303) is configured for receiving a relative movement in at least three spatial directions (x₁, x₂, y₁, y₂, z₁, z₂).
